(19) United States
(12) Patent Application Publication
(10) Pub. No.: US 2024/0276255 A1
(43) Pub. Date: Aug. 15, 2024

(54) Communication Apparatus and Method for Handling Radio Link Monitoring

(71) Applicant: MEDIATEK INC., Hsin-Chu (TW)

(72) Inventors: Chii-Horng Chen, Hsinchu City (TW); Shih-Chi Shen, Hsinchu City (TW); Yen-Hui Yeh, Hsinchu City (TW); Ping-Hung Chiang, Hsinchu City (TW)

(73) Assignee: MEDIATEK INC., Hsin-Chu (TW)

(21) Appl. No.: 18/110,351

(22) Filed: Feb. 15, 2023

(51) Int. Cl. H04W 24/08

(52) U.S. Cl. CPC H04W 24/08

(57) ABSTRACT

A method for handling radio link monitoring (RLM) includes: receiving downlink (DL) data from a network device; performing a first measurement according to the DL data, to generate a first measurement result of the DL data; comparing the first measurement result and a first threshold, to determine a first indication; comparing the first measurement result and a second threshold, to determine a second indication; and determining whether a radio link failure (RLF) occurs according to at least one of the first indication and the second indication.

### BACKGROUND

Long Term Evolution (LTE) is a set of enhancements to the Universal Mobile Telecommunications System (UMTS) mobile standard promulgated by 3rd generation partnership project (3GPP) for enabling high-speed packet communications. After LTE, 5G (fifth generation) New Radio (NR) is a new Radio Access Technology (RAT) developed by 3GPP for the 5G mobile network. The terminologies 3GPP access or 3GPP Radio Access Technology (RAT) may thus refer to the access technology or the RAT that is/are promulgated or developed by 3GPP.

In a wireless communication system (e.g., the LTE system and/or the 5G NR system), a communication apparatus connected to a network device or a cell of the network device needs to continuously perform the radio link monitoring (RLM) for a reliable communication. The downlink (DL) link quality of the communication apparatus is measured according to the RLM reference signal (RS), to detect/determine the radio link failure (RLF) of the communication apparatus. However, the RLF may be detected/determined incorrectly because of the mismatch (e.g., the quasi co-location (QCL) mismatch and/or the beamforming gain mismatch).

### SUMMARY

It is an objective of the invention to provide a communication apparatus and a method, in order to solve the above problem.

An embodiment of the invention provides a method for handling radio link monitoring (RLM) comprising: receiving downlink (DL) data from a network device; performing a first measurement according to the DL data, to generate a first measurement result of the DL data; comparing the first measurement result and a first threshold, to determine a first indication; comparing the first measurement result and a second threshold, to determine a second indication; and determining whether a radio link failure (RLF) occurs according to at least one of the first indication or the second indication.

An embodiment of the invention provides a communication apparatus comprising a radio transceiver and a processing circuit. The radio transceiver is configured to transmit or receive wireless signals. The processing circuit is coupled to the radio transceiver and configured to perform operations comprising: receiving downlink (DL) data from a network device; performing a first measurement according to the DL data, to generate a first measurement result of the DL data; comparing the first measurement result and a first threshold, to determine a first indication; comparing the first measurement result and a second threshold, to determine a second indication; and determining whether a radio link failure (RLF) occurs according to at least one of the first indication or the second indication.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is an exemplary block diagram of a communication apparatus according to an embodiment of the invention.

FIG. 2 is an exemplary block diagram of a modem according to an embodiment of the invention.

FIG. 3 is a flowchart of a process according to an embodiment of the invention.

FIG. 4 is a flowchart of a process according to an embodiment of the invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

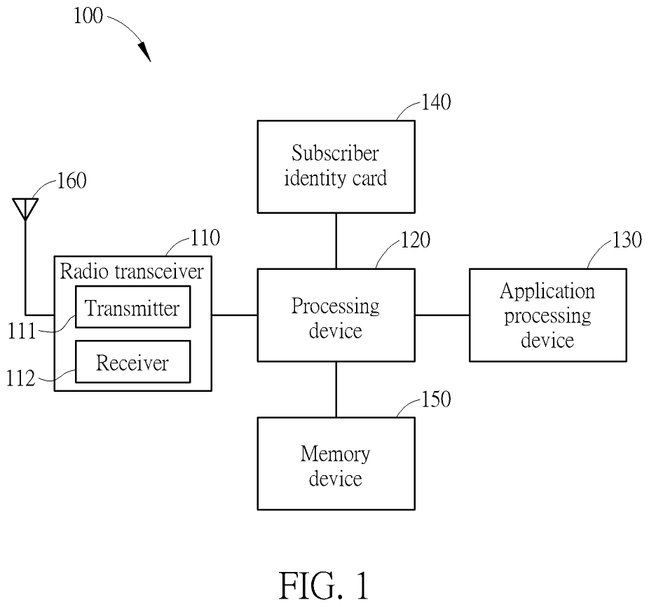

FIG. 1 is an exemplary block diagram of a communication apparatus 100 according to an embodiment of the invention. The communication apparatus 100 may be a portable electronic device, such as a Mobile Station (MS), which may be interchangeably referred to as User Equipment (UE). The communication apparatus 100 may comprise a radio transceiver 110, a processing device 120, an application processing device 130, a subscriber identity card 140, a memory device 150 and at least one antenna 160. The radio transceiver 110 may be configured to transmit and/or receive wireless signals to and/or from a network device (not shown) via the antenna(s) 160, so as to communicate with the network device via a communication link established between the communication apparatus 100 and the network device. The radio transceiver 110 may comprise a receiver 112 configured to receive wireless signals and a transmitter 111 configured to transmit wireless signals. The radio transceiver 110 may be further configured to perform radio frequency (RF) signal processing. For example, the receiver 112 may convert the received signals into intermediate frequency (IF) or baseband signals to be processed, or the transmitter 111 may receive the IF or baseband signals from the processing device 120 and convert the received signals into wireless signals to be transmitted to the network device in the wireless network or in an access network (e.g., a terrestrial network (TN), a non-terrestrial network (NTN), a wireless local area network (WLAN), a personal area network (PAN) or a wireless local access network). According to an embodiment of the invention, the network device may be a cell, a Node-B (NB), an evolved Node-B (eNB), a g Node-B (gNB), a base station, a Mobility Management Entity (MME), an Access and Mobility Management Function (AMF) device, etc., at the network side and communicating with the communication apparatus 100 by the wireless signals via the communication link.

The transmitter 111 and the receiver 112 of the radio transceiver 110 may comprise a plurality of hardware devices to perform RF conversion and RF signal processing. For example, the transmitter 111 and/or the receiver 112 may comprise a power amplifier for amplifying the RF signals, a filter for filtering unwanted portions of the RF signals and/or a mixer for performing radio frequency conversion. According to an embodiment of the invention, the radio frequency may be, for example, the frequency of any specific frequency band for a long-term evolution (LTE) system, the frequency of any specific frequency band for a 5G next generation (NR) system, the frequency of any specific frequency band for a WiFi system, or the frequency of any specific frequency band for a Bluetooth (BT) system, etc.

The processing device 120 may be configured to handle corresponding communication protocol operations and processing the signals received from or to be transmitted to the radio transceiver 110. The application processing device 130 is configured to run the operating system of the communication apparatus 100 and to run application programs installed in the communication apparatus 100. The processing device 120 and the application processing device 130 can be realized by means of hardware (circuitry), software, firmware (known as a combination of a hardware device and computer instructions and data that reside as read-only software on the hardware device), an electronic system, or combination thereof. In the embodiments of the invention, the processing device 120 and the application processing device 130 may be designed as discrete chips with some buses or hardware interfaces coupled therebetween, or they may be integrated into a combo chip (i.e., a system on chip (SoC)), and the invention should not be limited thereto.

The subscriber identity card 140 may be a subscriber identity module (SIM), universal mobile telecommunication system (UMTS) SIM (USIM), removable user identity module (R-UIM) or code division multiple access (CDMA) SIM (CSIM) card, or the like and may typically contain user account information, an International Mobile Subscriber Identity (IMSI) and a set of SIM application toolkit (SAT) commands and may provide storage space for phone book contacts. The memory device 150 may be coupled to the processing device 120 and the application processing device 130 and may store system data or user data.

It should be noted that, in order to clarify the concept of the invention, FIG. 1 presents a simplified block diagram in which only the elements relevant to the invention are shown. For example, in some embodiments of the invention, the communication apparatus 100 may further comprise some peripheral devices not shown in FIG. 1. In another example, in some embodiments of the invention, the communication apparatus 100 may further comprise a central controller coupled to the processing device 120 and the application processing device 130. Therefore, the invention should not be limited to what is shown in FIG. 1.

In some embodiments of the invention, the communication apparatus 100 is capable of supporting multiple radio access technologies (RATs) communications via the single-card structure as shown in FIG. 1. It should be noted that, although FIG. 1 shows a single-card application, the invention should not be limited herein. For example, in some embodiments of the invention, the communication apparatus 100 may comprise multiple subscriber identity cards to support the multi-RATs communications, in either a single-standby or a multiple-standby manner. In the multi-RATs communication applications, the modem, the radio transceiver and/or the antenna module may be shared by the subscriber identity card(s) and may have the capability of handling the operations of different RATs and processing the corresponding RF, IF or baseband signals in compliance with the corresponding communication protocols.

In addition, those who are skilled in this technology can still make various alterations and modifications based on the descriptions given above to derive the communication apparatuses comprising multiple radio transceivers and/or multiple antenna modules for supporting multi-RAT wireless communications without departing from the scope and spirit of this invention. Therefore, in some embodiments of the invention, the communication apparatus 100 may be designed to support a multi-card application, in either a single-standby or a multiple-standby manner, by making some alterations and modifications.

It should be further noted that the subscriber identity card 140 may be dedicated hardware cards as described above, or in some embodiments of the invention, there may be virtual cards, such as individual identifiers, numbers, addresses, or the like which are burned in the internal memory device of the corresponding modem and are capable of identifying the communication apparatus 100. Therefore, the invention should not be limited to what is shown in FIG. 1.

It should be further noted that in some embodiments of the invention, the communication apparatus 100 may further support multiple IMSIs.

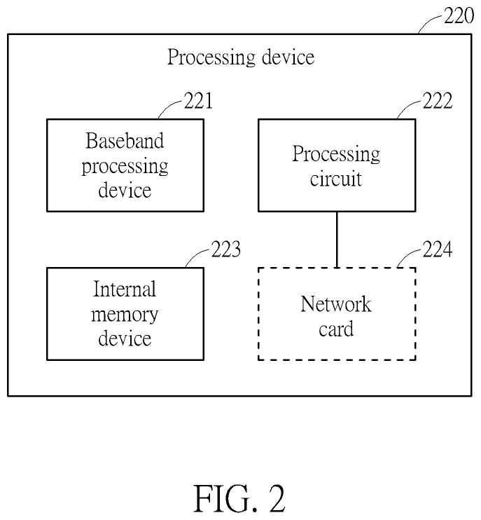

FIG. 2 is an exemplary block diagram of a processing device 220 according to an embodiment of the invention. The processing device 220 may be the processing device 120 shown in FIG. 1 and may comprise at least a baseband processing device 221, a processing circuit 222, an internal memory device 223 and a network card 224. The baseband processing device 221, the processing circuit 222, the internal memory device 223 and the network card 224 can be realized by means of hardware (circuitry), software, firmware, an electronic system, or combination thereof. The baseband processing device 221 may receive the IF or baseband signals from the radio transceiver 110 and perform IF or baseband signal processing. For example, the baseband processing device 221 may convert the IF or baseband signals into a plurality of digital signals, and process the digital signals, and vice versa. The baseband processing device 221 may comprise a plurality of hardware circuits to perform signal processing, such as an analog-to-digital converter for ADC conversion, a digital-to-analog converter for DAC conversion, an amplifier for gain adjustment, a modulator for signal modulation, a demodulator for signal demodulation, an encoder for signal encoding, a decoder for signal decoding, and so on.

According to an embodiment of the invention, the baseband processing device 221 may be designed to have the capability of handling the baseband signal processing operations for different RATs and processing the corresponding IF or baseband signals in compliance with the corresponding communications protocols, so as to support the multi-RAT wireless communications. According to another embodiment of the invention, the baseband processing device 221 may comprise a plurality of sub-units, each being designed to have the capability of handling the baseband signal processing operations of one or more specific RATs and processing the corresponding IF or baseband signals in compliance with the corresponding communications protocols, so as to support the multi-RAT wireless communications. Therefore, the invention should not be limited to any specific way of implementation.

The processing circuit 222 may control the operations of the processing device 220. According to an embodiment of the invention, the processing circuit 222 may be a processor arranged to execute the program codes of the processing device 220. For example, the processing circuit 222 may maintain and execute the individual tasks, threads, and/or protocol stacks for different software modules. A protocol stack may be implemented so as to respectively handle the radio activities of one RAT. However, it is also possible to implement more than one protocol stack to handle the radio activities of one RAT at the same time, or implement only one protocol stack to handle the radio activities of more than one RAT at the same time, and the invention should not be limited thereto.

In some embodiments of the invention, the processing circuit 222 may be pure hardware dedicated to dealing with the proposed method for handling interference on a non-terrestrial network. This alternative design also falls within the scope of the present invention.

The processing circuit 222 may also read data from the subscriber identity card coupled to the processing device (e.g., the subscriber identity card 140 in FIG. 1), and write data to the subscriber identity card. The internal memory device 223 may store system data and user data for the processing device 220. The processing circuit 222 may also access the internal memory device 223.

The network card 224 provides Internet access services for the communication apparatus 100. It should be noted that, although the network card 224 shown in FIG. 2 is configured inside of the processing device 220, the invention should not be limited thereto. In some embodiments of the invention, the communication apparatus 100 may also comprise a network card configured outside of the processing device, or the communication apparatus 100 may also be coupled to an external network card for providing Internet access services. In some embodiments of the invention, the network card 224 may be a virtual network card, instead of a tangible card, that is created by the operating system of the communication apparatus 100. Therefore, the invention should not be limited to any specific implementation method.

It should be noted that, in order to clarify the concept of the invention, FIG. 2 presents simplified block diagrams in which only the elements relevant to the invention are shown. Therefore, the invention should not be limited to what is shown in FIG. 2.

It should be further noted that in some embodiments of the invention, the processing device 220 may also comprise more than one processing circuit and/or more than one baseband processing device. For example, the processing device 220 may comprise multiple processing circuits and/or multiple baseband processing devices for supporting multi-RAT operations. Therefore, the invention should not be limited to what is shown in FIG. 2.

It should be further noted that in some embodiments of the invention, the baseband processing device 221 and the processing circuit 222 may be integrated into one processing unit, and the processing device may comprise one or multiple such processing units, for supporting multi-RAT operations. Therefore, the invention should not be limited to what is shown in FIG. 2.

According to an embodiment of the invention, the processing circuit 222 and the application processing device 130 may comprise a plurality of logics designed for handling one or more functionalities. The logics may be configured to execute the program codes of one or more software and/or firmware modules, thereby performing the corresponding operations. When performing the corresponding operations by executing the corresponding programs, the logics may be regarded as dedicated hardware devices or circuits, such as dedicated processor sub-units. Generally, the processing circuit 222 may be configured to perform operations of relative lower protocol layers while the application processing device 130 may be configured to perform operations of relative higher protocol layers. Therefore, in some embodiments of the invention, the application processing device 130 may be regarded as the upper layer entity or upper layer processing circuit with respect to the processing circuit 222 and the processing circuit 222 may be regarded as the lower layer entity or lower layer processing circuit with respect to the application processing device 130.

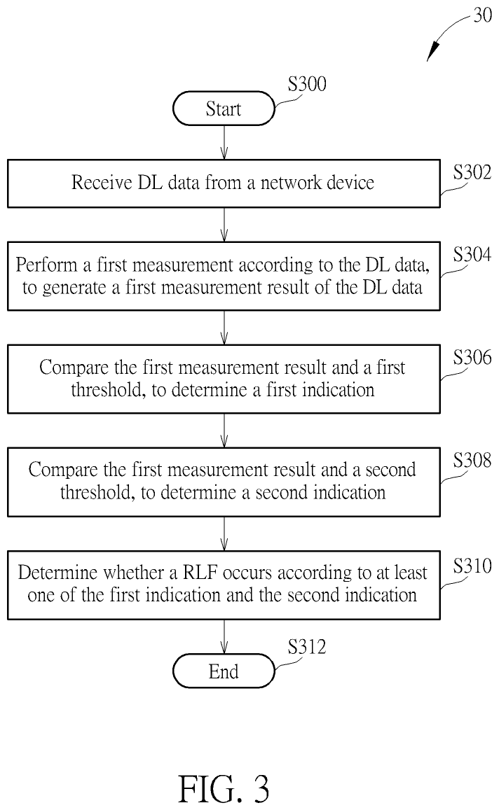

FIG. 3 is a flowchart of a process 30 utilized in a communication apparatus (e.g., the communication apparatus 100 shown in FIG. 1) according to an embodiment of the invention, to handle radio link monitoring (RLM). Provided that the result is substantially the same, the steps are not required to be executed in the exact order shown in FIG. 3. The process 30 comprises the following steps:

Step S300: Start.

Step S302: Receive downlink (DL) data from a network device.

Step S304: Perform a first measurement according to the DL data, to generate a first measurement result of the DL data.

Step S306: Compare the first measurement result and a first threshold, to determine a first indication.

Step S308: Compare the first measurement result and a second threshold, to determine a second indication.

Step S310: Determine whether a radio link failure (RLF) occurs according to at least one of the first indication and the second indication.

Step S312: End.

The processing circuit 222 is configured to perform steps of the process 30. According to the process 30, the communication apparatus 100 generates the first measurement result by performing the first measurement according to the DL data received from the network device. Then, the communication apparatus 100 determines the first indication by comparing the first measurement result and the first threshold, and determines the second indication by comparing the first measurement result and the second threshold. The communication apparatus 100 determines whether the RLF occurs according to at least one of the first indication and the second indication (e.g., a first number of the first indication indicating a “true” and/or a second number of the second indication indicating a “true”). That is, the communication apparatus 100 determines the first/second indication according to the measurement result of the DL data. Thus, the accuracy of determining the occurrence of the RLF is improved.

In the process 30, the communication device may perform one of the Steps S306 and S308, or may perform both of the Steps S306 and S308. That is, the communication device determines the at least one of the first indication and the second indication.

Realization of the process 30 is not limited to the above description. The following embodiments of the invention may be applied to realize the process 30.

In an embodiment of the invention, the communication apparatus 100 receives a reference signal (RS) from the network device, and performs a second measurement according to the RS to generate a second measurement result of the RS. Then, the communication apparatus 100 compares the first measurement result and the first threshold and compares the second measurement result and a third threshold, to determine the first indication. The communication apparatus 100 compares the first measurement result and the second threshold and compares the second measurement result and a fourth threshold, to determine the second indication. That is, the communication apparatus 100 determines the first/second indication according to not only the measurement result of the DL data but also the measurement result of the RS.

In an embodiment of the invention, the communication apparatus 100 (e.g., a lower layer (e.g., layer 1) of the communication apparatus 100) transmits the first indication to an upper layer (e.g., an upper layer (e.g., layer 2) of the communication apparatus 100) in response to the comparison of the first measurement result and the first threshold (and the comparison of the second measurement result and the third threshold). In an embodiment of the invention, the first indication indicates a “true” or a “false”. The Step S306 in the process 30 comprises that the communication apparatus 100 determines that the first indication indicates the “true”, when a first quality indicated by the first measurement result is smaller than the first threshold (and a second quality indicated by the second measurement result is smaller than the third threshold). Otherwise, the communication apparatus 100 determines that the first indication indicates the “false”. In an embodiment of the invention, the first indication is an out-of-sync (OOS) indication. The OOS indication indicating the “true” represents that a quality(s) of the RS and/or the DL data is poor. For example, a signal-to-noise ratio (SNR) of the RS is smaller than −10 dB.

In an embodiment of the invention, the communication apparatus 100 (e.g., the lower layer (e.g., layer 1) of the communication apparatus 100) transmits the second indication to the upper layer (e.g., the upper layer (e.g., layer 2) of the communication apparatus 100) in response to the comparison of the first measurement result and the second threshold (and the comparison of the second measurement result and the fourth threshold). In an embodiment of the invention, the second indication indicates a “true” or a “false”. The Step S308 in the process 30 comprises that the communication apparatus 100 determines that the second indication indicates the “true”, when the first quality indicated by the first measurement result is greater than the second threshold (or the second quality indicated by the second measurement result is greater than the fourth threshold). Otherwise, the communication apparatus 100 determines that the second indication indicates the “false”. In an embodiment of the invention, the second indication is an in-sync (IS) indication. The IS indication indicating the “true” represents that a quality(s) of the RS and/or the DL data is good. For example, an SNR of the RS is greater than −2 dB.

In an embodiment of the invention, the Step S310 in the process 30 comprises that: the communication apparatus 100 starts a timer, when the first number of the first indication (indicating the “true”) (consecutively) is equal to a first value; the communication apparatus 100 determines that the RLF does not occur and stops (or resets) the timer, when a second number of the second indication (indicating the “true”) (consecutively) is equal to a second value (e.g., N311) and the timer does not expire; and the communication apparatus 100 determines that the RLF occurs, when the timer expires. In an embodiment of the invention, the first value and the second value are predefined according to a communication standard. For example, the first value is N310, and the second value is N311.

In an embodiment of the invention, the RS is configured by the network device via an RRC message (e.g., RadioLinkMonitoringConfig). That is, the communication apparatus 100 may select the RS configured by the network device in an explicit radio link monitoring (RLM) mode. In an embodiment of the invention, the RS corresponds to an active transmission configuration indicator (TCI) for a control resource set (CORESET). The active TCI for the CORESET is used to receive data, messages and/or packets (e.g., physical DL control channel (PDCCH)), but is not limited herein. That is, the communication apparatus 100 may select the RS corresponding to the TCI in an implicit RLM mode.

In an embodiment of the invention, the RS comprises (e.g., is) at least one of a synchronization signal/physical broadcast channel (SS/PBCH) block (SSB) and a channel state information reference signal (CSI-RS), but is not limited herein. That is, the RS comprises (e.g., is) at least one RLM RS. In an embodiment of the invention, the second measurement result comprises (e.g., is) an SNR of the RS, but is not limited herein. That is, the second measurement result comprises (e.g., is) at least one second index for indicating a quality of the RS.

In an embodiment of the invention, the DL data comprises (e.g., is) at least one of a PDCCH and a physical DL shared channel (PDSCH), but is not limited herein. That is, the DL data comprises (e.g., is) signal(s), symbol(s), message(s) and/or packet(s) other than the RS. In an embodiment of the invention, the first measurement result comprises (e.g., is) at least one of a SNR of the DL data, a reference symbol received power (RSRP) of the DL data, an error rate (e.g., block error rate (BLER)) of the DL data and a throughput of the DL data, but is not limited herein. That is, the first measurement result comprises (e.g., is) at least one first index for indicating a quality of the DL data.

In an embodiment of the invention, the third threshold and the fourth threshold are predefined according to a communication standard. In an embodiment of the invention, the first threshold and the second threshold are determined according to at least one of a quasi co-location (QCL) status, a radio link monitoring (RLM) mode for the RS and an application of the communication apparatus, but is not limited herein. The QCL status is determined according to at least one of a QCL difference and a beamforming gain difference, but is not limited herein. The RLM mode comprises the explicit RLM mode and the implicit RLM mode. The explicit RLM mode and the implicit RLM mode can be referred to the previous description, and are not narrated herein. The application of the communication apparatus comprises an enhanced Mobile Broadband (eMBB), an Ultra Reliable Low Latency Communications (URLLC) and an enhanced Machine Type Communications (eMTC), but not is limited herein. The eMBB provides broadband services with a greater bandwidth and a low/moderate latency. The URLLC provides end-to-end communications with properties of a higher reliability and a low latency. The eMTC is able to support internet-of-things (IoT) of a communication system which include billions of connected devices and/or sensors.

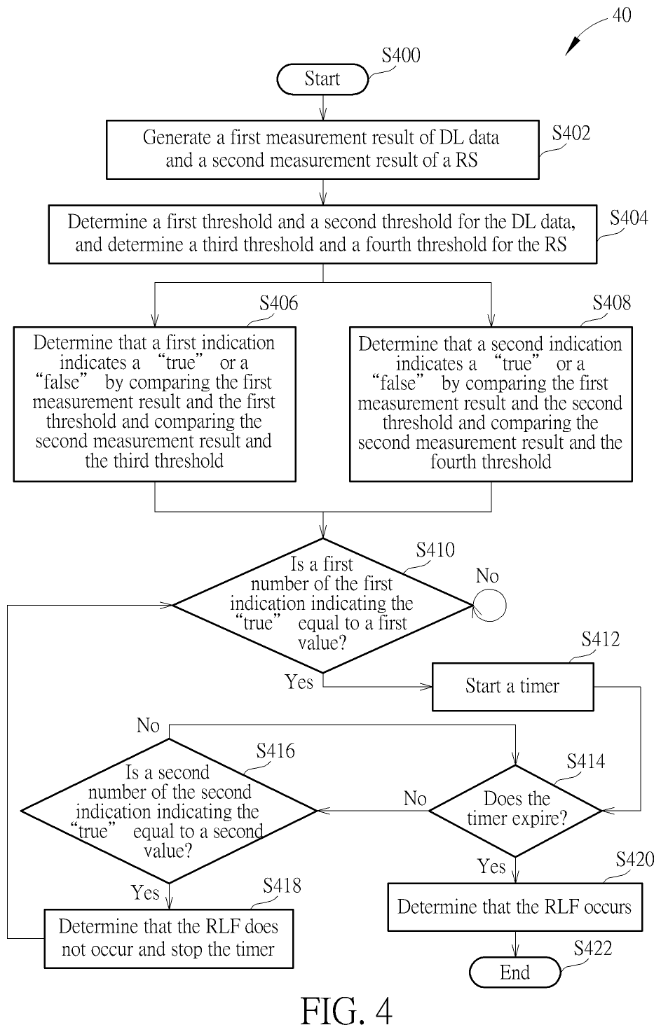

Operations of the communication apparatus 100 in the above examples can be summarized into a process 40 shown in FIG. 4, which includes the following steps:

Step S400: Start.

Step S402: Generate a first measurement result of DL data and a second measurement result of a RS.

Step S404: Determine a first threshold and a second threshold for the DL data, and determine a third threshold and a fourth threshold for the RS.

Step S406: Determine that a first indication indicates a “true” or a “false” by comparing the first measurement result and the first threshold and comparing the second measurement result and the third threshold.

Step S408: Determine that a second indication indicates a “true” or a “false” by comparing the first measurement result and the second threshold and comparing the second measurement result and the fourth threshold.

Step S410: Is a first number of the first indication indicating the “true” equal to a first value? If yes, perform Step S412. If no, perform Step S410.

Step S412: Start a timer.

Step S414: Does the timer expire? If yes, perform Step S420. If no, perform Step S416.

Step S416: Is a second number of the second indication indicating the “true” equal to a second value? If yes, perform Step S418. If no, perform Step S414.

Step S418: Determine that the RLF does not occur and stop the timer.

Step S420: Determine that the RLF occurs.

Step S422: End.

A detailed description and variations of the process S40 can be understood by referring to the above description, and are not narrated herein.

The operation of “determine” described above may be replaced by the operation of “compute”, “calculate”, “obtain”, “generate”, “output, “use”, “choose/select”, “decide” or “is configured to”. The phrase of “according to” described above may be replaced by “in response to” or “by using”. The phrase of “corresponding to” described above may be replaced by “of” or “associated with”. The term of “via” described above may be replaced by “on”, “in” or “at”. The term of “when” described above may be replaced by “upon” or “in response to”.

To sum up, the present invention provides a communication apparatus and a method for handling RLM. The measurement result(s) of the RS and/or the DL data are considered to determine the indications that indicate the quality(s) of the RS and/or the DL data. The occurrence of the RLF is determined according to the indications. Therefore, the accuracy of determining the occurrence of the RLF may be improved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for handling radio link monitoring (RLM) of a communication apparatus, comprising:
receiving downlink (DL) data from a network device;
performing a first measurement according to the DL data, to generate a first measurement result of the DL data;
comparing the first measurement result and a first threshold, to determine a first indication;
comparing the first measurement result and a second threshold, to determine a second indication; and
determining whether a radio link failure (RLF) occurs according to at least one of the first indication and the second indication.

2. The method of claim 1, further comprising:
receiving a reference signal (RS) from the network device; and
performing a second measurement according to the RS, to generate a second measurement result of the RS;
wherein the first indication is determined by comparing the first measurement result and the first threshold and comparing the second measurement result and a third threshold;
wherein the second indication is determined by comparing the first measurement result and the second threshold and comparing the second measurement result and a fourth threshold.

3. The method of claim 2, wherein the RS is configured by the network device via a radio resource control (RRC) message.

4. The method of claim 2, wherein the RS corresponds to an active transmission configuration indicator (TCI) for a control resource set (CORESET).

5. The method of claim 2, wherein the RS comprises at least one of a synchronization signal/physical broadcast channel (SS/PBCH) block (SSB) and a channel state information reference signal (CSI-RS).

6. The method of claim 2, wherein the second measurement result comprises a signal-to-noise ratio (SNR) of the RS.

7. The method of claim 2, wherein the third threshold and the fourth threshold are predefined according to a communication standard.

8. The method of claim 1, wherein the operation of determining the RLF according to at least one of the first indication and the second indication comprises:
starting a timer, when a first number of the first indication is equal to a first value;
determining that the RLF does not occur and stopping the timer, when a second number of the second indication is equal to a second value and the timer does not expire; and
determining that the RLF occurs, when the timer expires.

9. The method of claim 8, wherein the first value and the second value are predefined according to a communication standard.

10. The method of claim 1, wherein the DL data comprises at least one of a physical DL control channel (PDCCH) and a physical DL shared channel (PDSCH).

11. The method of claim 1, wherein the first measurement result comprises at least one of a SNR of the DL data, a reference symbol received power (RSRP) of the DL data, an error rate of the DL data and a throughput of the DL data.

12. The method of claim 1, wherein the first threshold and the second threshold are determined according to at least one of a quasi co-location (QCL) status, a RLM mode for the RS and an application of the communication apparatus.

13. The method of claim 12, wherein the QCL status is determined according to at least one of a QCL difference and a beamforming gain difference.

14. The method of claim 12, wherein the RLM mode comprises an explicit RLM mode and an implicit RLM mode.

15. The method of claim 12, wherein the application of the communication apparatus comprises an enhanced Mobile Broadband (eMBB), an Ultra Reliable Low Latency Communications (URLLC) and an enhanced Machine Type Communications (eMTC).

16. A communication apparatus, comprising:
a radio transceiver, configured to transmit or receive wireless signals; and
a processing circuit, coupled to the radio transceiver and configured to perform operations comprising:
receiving downlink (DL) data from a network device;
performing a first measurement according to the DL data, to generate a first measurement result of the DL data;
comparing the first measurement result and a first threshold, to determine a first indication;
comparing the first measurement result and a second threshold, to determine a second indication; and
determining whether a radio link failure (RLF) occurs according to at least one of the first indication and the second indication.

17. The communication apparatus of claim 16, wherein the operations further comprise:
receiving a reference signal (RS) from the network device; and
performing a second measurement according to the RS, to generate a second measurement result of the RS;
wherein the first indication is determined by comparing the first measurement result and the first threshold and comparing the second measurement result and a third threshold;
wherein the second indication is determined by comparing the first measurement result and the second threshold and comparing the second measurement result and a fourth threshold.

18. The communication apparatus of claim 16, wherein the operation of determining the RLF according to at least one of the first indication and the second indication comprises:
starting a timer, when a first number of the first indication is equal to a first value;
determining that the RLF does not occur and stopping the timer, when a second number of the second indication is equal to a second value and the timer does not expire; and
determining that the RLF occurs, when the timer expires.
